(19) United States
(12) Patent Application Publication
(10) Pub. No.: US 2015/0021931 A1
(43) Pub. Date: Jan. 22, 2015

(54) VEHICLE DOOR LATCH SYSTEM AND METHOD

(71) Applicant: GM GLOBAL TECHNOLOGY OPERATIONS LLC, Detroit, MI (US)

(72) Inventors: JEFFREY L. KONCHAN, ROMEO, MI (US); FRANK J. ARABIA, Jr., MACOMB, MI (US); RICHARD J. LANGE, TROY, MI (US)

(21) Appl. No.: 13/945,157

(22) Filed: Jul. 18, 2013

(51) Int. Cl. E05B 81/04; E05B 83/36; E05B 47/00

(52) U.S. Cl. CPC E05B 81/04; E05B 47/0001; E05B 83/36
USPC 292/194; 49/506

(57) ABSTRACT

A door latch system for a vehicle having a front door and a back door includes electric latch mechanisms associated with each door. Open switches are associated with each door to request opening of the doors. Lock switches are associated with each door to request locking and unlocking of the doors. An override switch is associated with the front passenger door and configured to send at least one of an override signal and an enabled signal. A controller prevents unlocking of the doors using the lock switches associated with the back doors unless the back door is open.

### TECHNICAL FIELD

The technical field generally relates to door latches for vehicles, and more particularly relates to electrically-actuated door latches for vehicles.

### BACKGROUND

Automobiles have long utilized door lock mechanisms to prevent unauthorized access to the vehicles. The earliest such mechanisms were purely mechanical in nature. To actuate these purely mechanical mechanisms, a user would manually utilize a lever, a post, and/or a tumbler lock to move the mechanism between a locked state and an unlocked state through a series of linkages. More recently, electric solenoids and/or motors have been added to such mechanical mechanism to allow actuation of the mechanism between states via a switch and/or “key-fob”.

Even more recently, automobiles have been implemented without the manual linkages between levers, posts, and/or tumbler locks and the door lock mechanism. Instead, actuation of the mechanism between locked and unlocked states is purely electrically controlled. However, some issues with this approach have been identified. For instance, occupants in the back seat of the vehicle may inadvertently utilize an unlock switch to unlock the doors. Therefore, it is desirable to provide means to prohibit unauthorized unlocking of the doors.

Furthermore, other desirable features and characteristics of the present invention will become apparent from the subsequent detailed description and the appended claims, taken in conjunction with the accompanying drawings and the foregoing technical field and background.

### SUMMARY

A door latch system for a vehicle is provided. The vehicle includes a front passenger door and a back passenger door. A front electric door latch mechanism is associated with the front passenger door and a back electric door latch mechanism is associated with the back passenger door. Each of the mechanisms is movable between a latched position in which the respective passenger door is securely closed and an unlatched position in which the respective passenger door is openable. A front open switch is associated with the front passenger door and a back open switch is associated with the back passenger door. Each open switch is configured to send a door open signal. The system also includes a front lock switch associated with the front passenger door and a back lock switch associated with the back passenger door. Each lock switch is configured to send at least one of a door lock signal and a door unlock signal. An override switch is associated with the front passenger door and configured to send at least one of an override signal and an enabled signal. The system further includes a controller in communication with the mechanisms and the switches. The controller is configured to assign an unlocked state to each of the open switches in response to receiving the door unlock signal from the front lock switch. The controller is also configured to assign an unlocked state to each of the open switches in response to receiving the door unlock signal from the back lock switch and the enabled signal from the override switch. The controller is further configured to move the front electric door latch mechanism to the unlatched position in response to receiving the door open signal from the front door open switch if the front open switch is assigned the unlocked state and to move the back electric door latch mechanism to the unlatched position in response to receiving the door open signal from the back door open switch if the back open switch is assigned the unlocked state.

A method is provided for operating an electric door latch mechanism of a vehicle having a front passenger door and a back passenger door. The mechanism is movable between a latched position in which the back passenger door is secured and an unlatched position in which the back passenger door is openable. A back open switch is associated with the back passenger door, a front lock switch is associated with the front passenger door, a back lock switch is associated with the back passenger door, an override switch is associated with the front passenger door, and a controller is in communication with the switches and the mechanism. The method includes receiving a door open signal from at least one of the front lock switch and the back lock switch. The method further includes receiving an enabled signal from the override switch. The method also includes assigning the unlocked state to the back open switch in response to receiving the unlock signal from the front lock switch. The method further includes assigning the unlocked state to the back open switch in response to receiving the unlock signal from the back lock switch and receiving an enabled signal from the lock state override switch. The electric door latch mechanism is moved to the unlatched position in response to receiving an open request from the back open switch if the back open switch is assigned the unlocked state.

### DESCRIPTION OF THE DRAWINGS

The exemplary embodiments will hereinafter be described in conjunction with the following drawing figures, wherein like numerals denote like elements, and wherein:

FIG. 1 is a side-view of a vehicle in accordance with an embodiment;

FIG. 2 is a top-view of the vehicle in accordance with an embodiment;

FIG. 3 is a perspective view of a front door of the vehicle in accordance with an embodiment;

FIG. 4 is a perspective view of a back door of the vehicle in accordance with an embodiment;

FIG. 5 is a block schematic diagram of a door latch system of the vehicle in accordance with an embodiment; and

FIG. 6 is a flowchart of a method of operating a door latch system of the vehicle in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Referring to the figures, wherein like numerals indicate like parts throughout the several views, an electric door latch system 500 for a vehicle 100 and method of operation is shown and described herein.

The vehicle 100 of the exemplary embodiments is an automobile (not separately numbered) having an engine (not shown) coupled to a transmission (not shown) to drive a plurality of wheels (not numbered), as is appreciated by those skilled in the art. The transmission of the exemplary embodiments is an automatic transmission which includes a “park” mode and at least one “drive” mode, as is customary. However, the door latch system 500 described herein may be implemented in automobiles having other types of transmissions or other types of vehicles 100 in general.

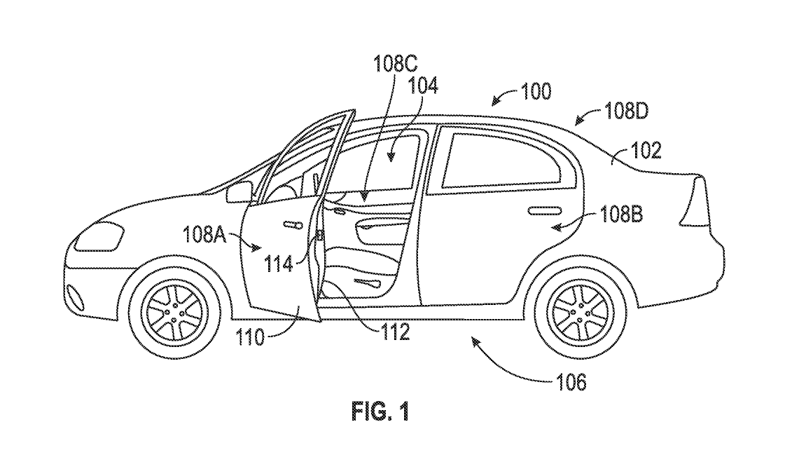

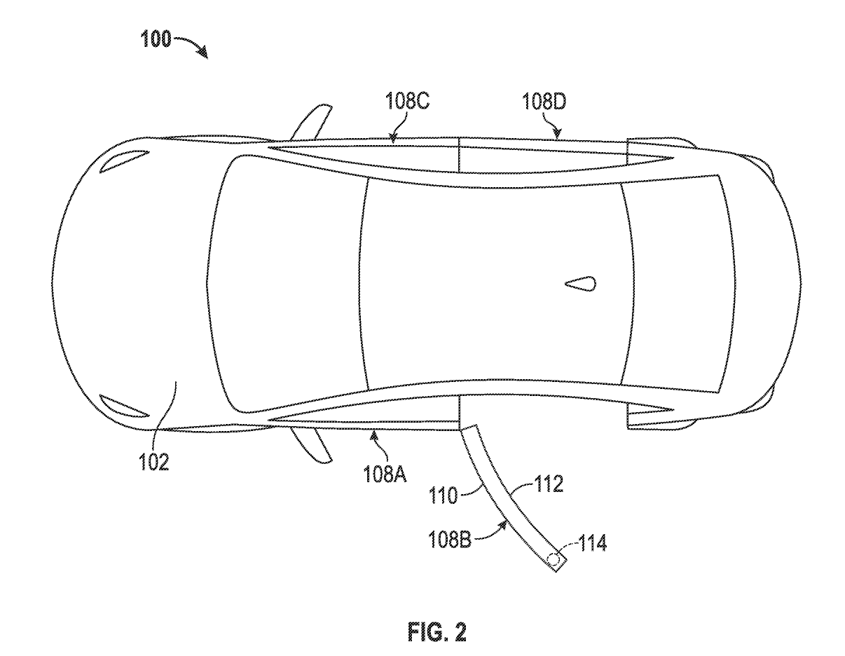

Referring to FIG. 1, the vehicle 100 has a body 102 defining an inside 104 and an outside 106, as is well appreciated by those skilled in the art. The inside 104 of the vehicle may be referred to as a passenger compartment. The vehicle 100 of the exemplary embodiment includes four passenger doors 108A, 108B, 108C, 108D to allow ingress and egress from the passenger compartment, as best shown in FIG. 2. Specifically, in the exemplary embodiment, the vehicle 100 includes a left front passenger door 108A, a left rear passenger door 108B, a right front passenger door 108C, and a right rear passenger door 108D. In this exemplary embodiment, the terms “left” and “right” refer to the sides (not numbered) of the vehicle 100 relative to a person facing a forward direction, the term “front” refers to the positions located closer to the front with respect to the forward direction, and the term “back” refers to positions located behind the front, i.e., the back, with respect to the forward direction. However, the terms “left”, “right”, “front”, and “back”, as used with reference to the passenger doors 108A, 108B, 108C, 108D, may be treated as arbitrary identifiers to simply differentiate one passenger door 108A, 108B, 108C, 108D from another. Furthermore, in other embodiments, the vehicle 100 may include more or less than the four passenger doors 108A, 108B, 108C, 108D. The vehicle 100 may also include cargo doors (not numbered), e.g., a trunk lid or hatchback, that may or may not provide access to the passenger compartment. In the exemplary embodiment, the front passenger doors 108A, 108C provide access to one or more front seats (not shown) while the back passenger doors 108B, 108D provide access to one or more back seats (not shown).

With reference again to FIG. 1, each door 108A, 108B, 108C, 108D includes an exterior side 110 and an interior side 112. The exterior side 110 generally faces the outside 106 of the vehicle 100 and the interior side 112 generally faces the inside 104 of the vehicle 100. Said another way, the exterior side 110 is associated with the outside 106 of the vehicle 100 and the interior side 112 is associated with the inside 104 of the vehicle 100.

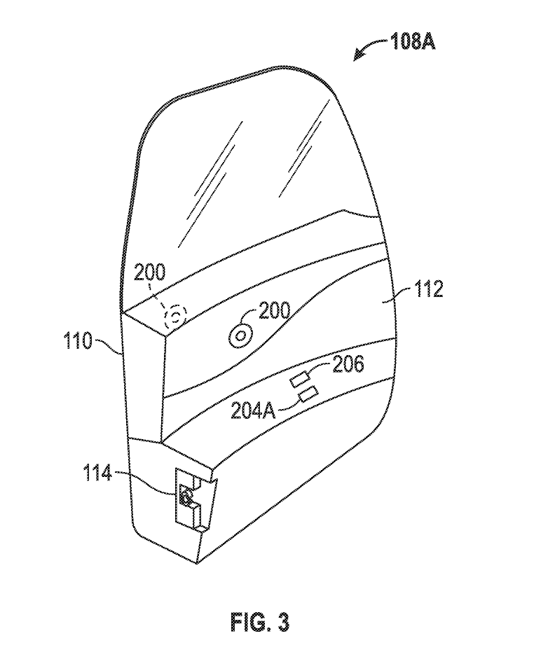

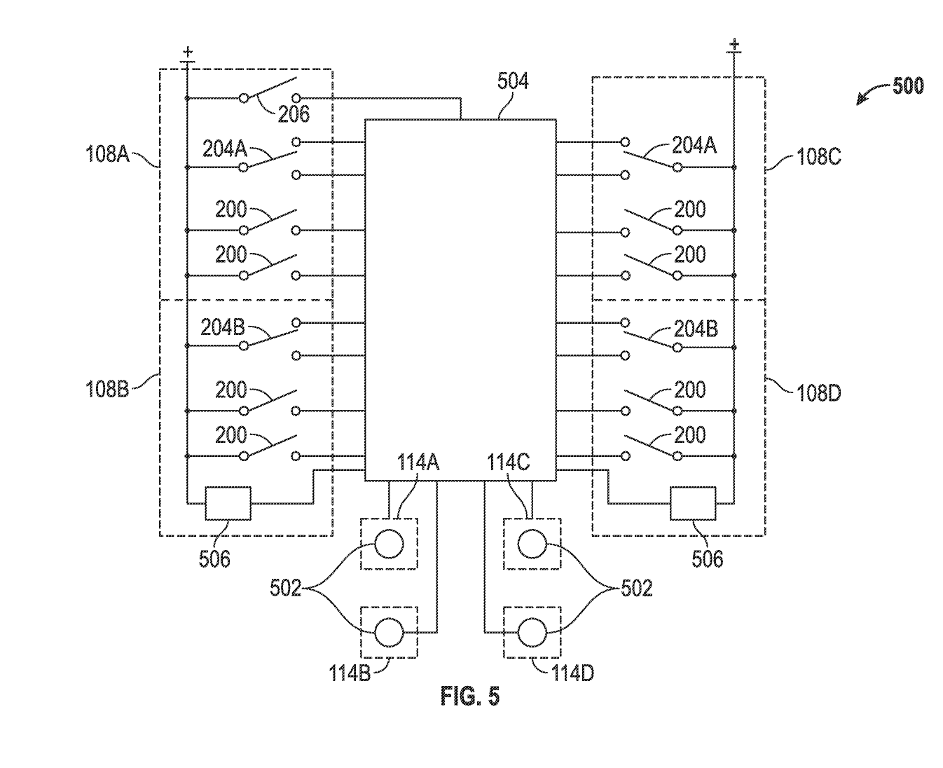

The left front passenger door 108A includes a left front electric door latch mechanism 114A, as shown in FIG. 3, and the left back passenger door 108B includes a left back electric door latch mechanism 114B. In the exemplary embodiment, the remaining doors 108C, 108D also include door latch mechanisms 114C, 114D, shown only in FIG. 5. Each electric door latch mechanism 114A, 114B, 114C, 114D is movable between a latched position, in which the respective passenger door 108A, 108B, 108C, 108D is securely closed, and an unlatched position, in which the respective passenger door 108A, 108B is openable.

For example, the door latch mechanism 114A, 114B, 114C, 114D may include a fork bolt lever (not numbered) engagable with a striker (not shown). The fork bolt lever is securely latched with the striker when the door latch mechanism 114A, 114B, 114C, 114D is in the latched position and is released from the striker when the respective door latch mechanism 114A, 114B, 114C, 114D is in the unlatched position. Each door latch mechanism 114A, 114B, 114C, 114D may include an electric motor 502, as shown in FIG. 5, or other electrically-actuated mechanism to regulate movement of the door latch mechanism 114A, 114B between the latched position and the unlatched position.

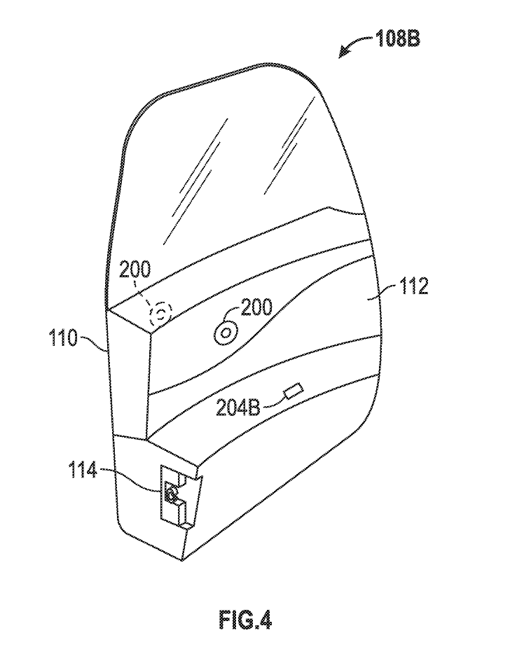

Referring to FIGS. 3-5, the vehicle 100 includes a plurality of open switches 200. Specifically, in the exemplary embodiment, the vehicle 100 includes one open switch 200 disposed on the on the exterior side 110 of each door 108A, 108B, 108C, 108D and another open switch 200 disposed on the interior side 112 of each door 108A, 108B, 108C, 108D. As such, there is at least one front open switch 200 associated with each front passenger door 108A, 108C and at least one back open switch 200 associated with each back passenger door 108, 108D. A user may actuate one of the open switches 200 to send a door open signal to request that the respective door 108A, 108B, 108C, 108D be unlatched from the body 102. More specifically, a user may actuate any of the switches 200 to request that the respective electric door latch mechanism 114A, 114B moves to the unlatched position.

Each open switch 200 may be operatively connected to a hinged handle (not numbered) such that when a user actuates the handle, the unlatch request is received by the respective open switch 200. Alternatively, the each open switch 200 may be a push button (not numbered). Furthermore, one or more of the open switches 200 may not be mechanical in nature, as is shown in FIG. 5. For instance, the open switch 200 may be represented by an icon (not shown) on a display (not shown) wherein selection of the icon triggers the door open signal to be sent. Those skilled in the art will realize other types and styles of switches to implement the interior and exterior open switches 200.

The open switches 200 of the exemplary embodiment are mechanically isolated from the electric door latch mechanisms 114A, 114B, 114C, 114D. That is, there is no mechanical connection between the open switches 200 and the door latch mechanism 114A, 114B, 114C, 114D. As such, movement of the door latch mechanisms 114A, 114B, 114C, 114D between latched and unlatched position is only accomplished in response to receipt of an electrical signal. However, in other embodiments, one or more of the doors 108A, 108B, 108C, 108D may include a backup or redundant mechanical linkage (not shown) operatively connected between a handle (not shown) and the respective door latch mechanism 114A, 114B, 114C, 114D. This mechanical linkage is configured to move the door latch mechanism 114A, 114B, 114C, 114D between its latched and unlatched positions.

The vehicle 100 also includes a plurality of lock switches 204A, 204B. The lock switches 204A, 204B are each configured to send at least one of a door lock signal and a door unlock signal. More specifically, in the exemplary embodiment, each lock switch 204A, 204B is configured to non-simultaneously send the door lock signal and the door unlock signal, depending on the selection of the user. Furthermore, one or more of the lock switches 204A, 204B may not be mechanical in nature, as is shown in FIG. 5. For instance, the lock switch 204A, 204B may be represented by an icon (not shown) on a display (not shown) wherein selection of the icon triggers the door open signal to be sent. Those skilled in the art will realize other types and styles of switches to implement the open switches 204A, 204B.

Each lock switch 204A, 204B is associated with one of the passenger doors 108A, 108B, 108C, 108D. For example, in the exemplary embodiment, one lock switch 204A, 204B is coupled to the interior 112 of each passenger door 108A, 108B, 108C, 108D. Thus, the vehicle 100 of the exemplary embodiment includes a left front lock switch 204A associated with the left front passenger door 108A, a left back lock switch 204B associated with the left back passenger door 108B, a right front lock switch 204A associated with the right front passenger door 108C, and a right back lock switch 204B associated with the right back passenger door 108D.

The lock switches 204A, 204B are each mechanically isolated from the electric door latch mechanisms 114A, 114B of the respective passenger doors 108A, 108B, 108C, 108D. That is, no mechanical linkage exists between the lock switch 204A, 204B and the movable parts of the door latch mechanisms 114A, 114B.

The vehicle 100 further includes at least one override switch 206. Specifically, in the exemplary embodiment, one override switch 206 is coupled to the interior 112 of the left front passenger door 108A, as is shown in FIG. 3. However, in other embodiments, the override switch 206 may be coupled to other or additional passenger doors 108A, 108B, 108C, 108D. For example, an additional override switch 206 (not shown) may be coupled to the right front passenger door 108C. The override switch(es) 206 need not be mechanical in nature, as is shown in FIG. 5. For instance, the override switch 206 may be represented by an icon (not shown) on a display (not shown) wherein selection of the icon triggers the door open signal to be sent. Those skilled in the art will realize other types and styles of switches to implement override switch 206.

The at least one override switch 206 is configured to send at least one of an override signal and an enabled signal. More specifically, the override switch 206 is configured to non-simultaneously send the override signal and enabled signal, depending on the selection of the user. More specifically, the at least one override switch 206 of the exemplary embodiment sends the override signal when selected, but otherwise sends the enabled signal.

Referring to FIG. 5, the door latch system 500 further includes a controller 504. The controller 504 may comprise a computer, a processor, a microprocessor, an application specific integrated circuit (“ASIC”), digital logic gates, and/or another suitable device capable of receiving data and executing instructions in response to the received data. In the exemplary embodiment. Furthermore, the controller 504 of the door latch system 500 may be part of a vehicle control unit (not shown) which controls other aspects of the vehicle 100 as well.

The controller 504 is in communication with the door latch open switches 200, the lock switches 204, and the override switch 206. The switches 200, 204, 206 may be electrically connected (either directly or indirectly) to the controller 504 to facilitate the communication therebetween. However, in other embodiments, radio frequency (RF) or other communication techniques may be implemented. As such, the controller 504 may receive signals and/or other data generated by these switches 200, 204, 206.

The controller 504 is also in communication with the door latch mechanisms 114A, 114B, 114C, 114D. The controller 504 is configured to control movement of the electric door latch mechanism 114A, 114B, 114C, 114D between the latched and unlatched positions. That is, the controller 504 may send a control signal carrying an unlatch command to the electric door latch mechanisms 114A, 114B, 114C, 114D. In the exemplary embodiment, the controller 504 is in communication with the electric motor 502 of each door latch mechanism 114A, 114B, 114C, 114D to control operation of the electric motor 502. The electric door latch mechanisms 114A, 114B, 114C, 114D may each include a motor starter (not shown) or other drive circuit to control operation of the electric motor 502. Of course, other configurations of the electric door latch mechanisms 114A, 114B, 114C, 114D will be realized by those skilled in the art.

The controller 504 is configured to assign either a locked state or an unlocked state for each of the open switches 200. In response to receiving the door open signal from one of the open switches 200 in the unlocked state, the controller 504 will send the unlatch command to the respective electric door latch mechanism 114A, 114B, 114C, 114D. Moreover, the electric door latch mechanisms 114A, 114B, 114C, 114D will be commanded to open only when the respective open switch 200 is in the unlocked state. If one of the open switches 200 is in the locked state, then the controller 504 will not send the unlatch command to the respective electric door latch mechanism 114A, 114B, 114C, 114D. In essence, the controller 504 will simply ignore open signals from open switches 200 assigned the locked state.

The assignation of the locked state or the unlocked state to the open switches 200 may be set or changed utilizing the lock switches 204A, 204B. In the exemplary embodiment, the controller 504 is configured to assign an unlocked state to each of the open switches 200 in response to receiving the door unlock signal from one of the front lock switches 204A. That is, if the lock switch 204A associated with the left front door 108A or the right front door 108C is actuated, then every open switch 200 will be assigned the unlocked state. As such, the driver and/or passenger in the front-most positions of the vehicle can control the ability for any passengers to open their respective door 108A, 108B, 108C, 108D. The controller 504 is also configured to assign a locked state to each of the open switches 200 in response to receiving a door lock signal from any of the lock switches 204A, 204B.

The controller 504 of the exemplary embodiment is also configured to assign an unlocked state to each of the open switches 200 in response to receiving the enabled signal from the override switch 206 and the door unlock signal from one of the back lock switches 204B associated with one of the back doors 108B, 108D. Conversely, the controller 504 will not assign an unlocked state to each of the open switches 200 if the override signal is received from the override switch 206 and the door unlock signal from one of the back lock switches 204B is received. In other words, the back lock switches 204B may be essentially deactivated by the override switch 206 in one embodiment. By overriding the function of the back lock switches 204B with the override switch 206, front seat occupants, e.g., adults, can prevent back seat occupants, e.g., children, from unlocking and consequently opening the back passenger doors 108B, 108D.

The system 500 may further include one or more position sensors 506 for sensing the position of at least one of the back passenger doors 108B, 108D. Each position sensor 506 may be implemented as a mechanical switch or by other techniques known by those skilled in the art. Each position sensor 506 sends a door opened signal in response to the respective back passenger door 108B, 108D being open, i.e., in an opened position.

In the exemplary embodiment, the controller 504 of the exemplary embodiment is further configured to assign an unlocked state to each of the open switches 200 in response to receiving the door opened signal from the position sensor 506 and receiving a the door unlock signal from the respective back lock switch 204B. As such, the back lock switch 204B may be used to lock and/or unlock the doors 108A, 108B, 108C, 108D of the vehicle 100 when the respective back door 108B, 108D is open, regardless of the override switch 206 setting. This allows users, e.g., adults, to lock or unlock the doors 108A, 108B, 108C, 108D after assisting children in the back seat.

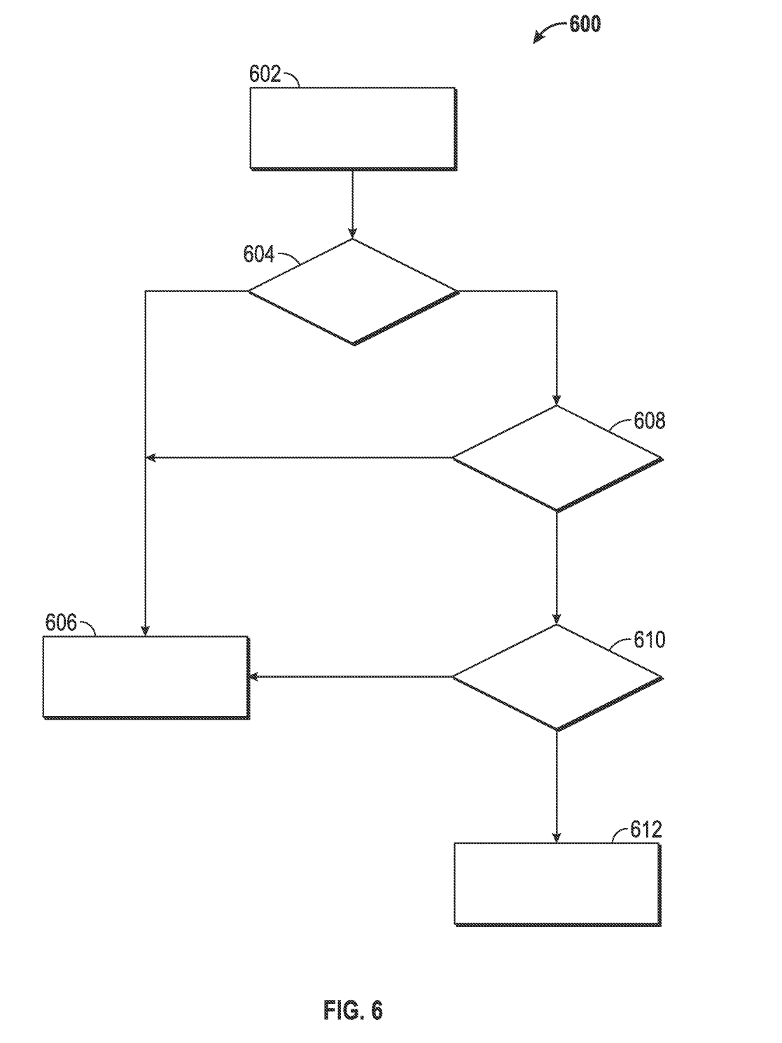

One exemplary method 600 of operating a door latch system is shown in FIG. 6. The method begins with the step 602 of receiving a door unlock signal from one of the lock switches 204A, 204B. The method 600 continues with the step 604 of determining which lock switch 204A, 204B generated the door unlock signal. If the door unlock signal was generated by the front lock switch 204A associated with one of the front passenger doors 108A, 108C, then the method 600 continues with the step 606 of assigning the unlocked state to each of the open switches 200, thus making it possible to open the doors 108A, 108B, 108C, 108D. If the door unlock signal was generated by the back lock switch 204B associated with one of the back passenger doors 108B, 108D, then additional information must be considered. The method 600 includes step 608 of determining if an enabled signal has been received from the override switch 206. If an enabled signal has been received, then the method 600 continues with the step 606 of assigning the unlocked state to each of the open switches 200. If the enabled signal has not been received, then the method continues with the step 610 of determining if the respective back passenger door 108B, 108D is open. If the door 108B, 108D is open, then the method continues with the step 606 of assigning the unlocked state to each of the open switches 200. If the door 108B, 108D is not open, then the method continues with the step 612 of making no changes to the state of the open switches 200.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of operating an electric door latch mechanism of a vehicle having a front passenger door and a back passenger door, the mechanism movable between a latched position in which the back passenger door is secured and an unlatched position in which the back passenger door is openable, a back open switch associated with the back passenger door, a front lock switch associated with the front passenger door, a back lock switch associated with the back passenger door, an override switch associated with the front passenger door, and a controller in communication with the switches and the mechanism, said method comprising:
receiving a door unlock signal from at least one of the front lock switch and the back lock switch;
receiving an enabled signal from the override switch;
assigning the unlocked state to the back open switch in response to receiving the unlock signal from the front lock switch;
assigning the unlocked state to the back open switch in response to receiving the unlock signal from the back lock switch and receiving an enabled signal from the lock state override switch;
moving the electric door latch mechanism to the unlatched position in response to receiving an open request from the back open switch if the back open switch is assigned the unlocked state.

2. A method as set forth in claim 1 wherein the electric door latch mechanism is further defined as a back electric door latch mechanism and the vehicle further includes a front electric door latch mechanism movable between a latched position in which the front passenger door is secured and a unlatched position in which the front passenger door is openable, said method further comprising
assigning the unlocked state to the each of the open switches in response to receiving the unlock signal from the front lock switch; and
assigning the unlocked state to each of the open switches in response to receiving the unlock signal from the back lock switch and receiving an enabled signal from the lock state override switch.

3. A method as set forth in claim 2 further comprising moving the front electric door latch mechanism to the unlatched position in response to receiving an open request from the front open switch if the front open switch is assigned the unlocked state.

4. A method as set forth in claim 2 wherein the vehicle includes a position sensor in communication with the controller for sensing an opened position of the back passenger door and sending a door opened signal to the controller, wherein said method further comprises assigning the unlocked state to each of the open switches in response to receiving the door unlock signal from the back lock switch and a door opened signal from a position sensor.

5. A method as set forth in claim 2 further comprising assigning a locked state to each of the open switches in response to receiving the door lock signal from any of said lock switches.

6. A door latch system for a vehicle having a front passenger door and a back passenger door, said system comprising:
a front electric door latch mechanism associated with the front passenger door and a back electric door latch mechanism associated with the back passenger door, wherein each of said mechanisms is movable between a latched position in which the respective passenger door is securely closed and an unlatched position in which the respective passenger door is openable;
a front open switch associated with the front passenger door and a back open switch associated with the back passenger door wherein each open switch is configured to send a door open signal;
a front lock switch associated with the front passenger door and a back lock switch associated with the back passenger door wherein each lock switch is configured to send at least one of a door lock signal and a door unlock signal;
an override switch associated with the front passenger door and configured to send at least one of an override signal and an enabled signal; and
a controller in communication with said mechanisms and said switches,
said controller configured to assign an unlocked state to each of the open switches in response to receiving the door unlock signal from said front lock switch;
said controller configured to assign an unlocked state to each of the open switches in response to receiving the door unlock signal from said back lock switch and the enabled signal from said override switch;
said controller configured to move said front electric door latch mechanism to the unlatched position in response to receiving the door open signal from the front door open switch if the front open switch is assigned the unlocked state; and
said controller configured to move said back electric door latch mechanism to the unlatched position in response to receiving the door open signal from the back door open switch if said back open switch is assigned the unlocked state.

7. A system as set forth in claim 6 further comprising a position sensor for sensing an opened position of the back passenger door and sending a door opened signal.

8. A system as set forth in claim 7 wherein said controller is in communication with said position sensor and configured to assign the unlocked state to each of said open switches in response to receiving the door unlock signal from said back lock switch and the door opened signal.

9. A system as set forth in claim 6 wherein said controller is configured to assign a locked state to each of the open switches in response to receiving the door lock signal from any of said lock switches.

10. A system as set forth in claim 6 wherein said open switches are mechanically isolated from said electric door latch mechanisms.

11. A system as set forth in claim 6 wherein said lock switches are mechanically isolated from said electric door latch mechanisms.

12. A vehicle, comprising:
a front passenger door;
a back passenger door;
a front electric door latch mechanism associated with said front passenger door and a back electric door latch mechanism associated with said back passenger door wherein each of said mechanisms is movable between a latched position in which said respective passenger door is securely closed and an unlatched position in which said respective passenger door is openable;
a front open switch associated with said front passenger door and a back open switch associated with said back passenger door wherein each open switch is configured to send a door open signal;
a front lock switch associated with said front passenger door and a back lock switch associated with said back passenger door wherein each lock switch is configured to send at least one of a door lock signal and a door unlock signal;
an override switch associated with said front passenger door and configured to send at least one of an override signal and an enabled signal; and
a controller in communication with said mechanisms and said switches,
said controller configured to assign an unlocked state to each of the open switches in response to receiving the door unlock signal from said front lock switch;
said controller configured to assign an unlocked state to each of the open switches in response to receiving the door unlock signal from said back lock switch and the enabled signal from said override switch;
said controller configured to move said front electric door latch mechanism to the unlatched position in response to receiving the door open signal from said front door open switch if the front open switch is assigned the unlocked state; and
said controller configured to move said back electric door latch mechanism to the unlatched position in response to receiving the door open signal from said back door open switch if said back open switch is assigned the unlocked state.

13. A vehicle as set forth in claim 12 further comprising a position sensor for sensing an opened position of said back passenger door and sending a door opened signal.

14. A vehicle as set forth in claim 13 wherein said controller is in communication with said position sensor and configured to assign the unlocked state to each of said open switches in response to receiving the door unlock signal from said back lock switch and the door opened signal.

15. A vehicle as set forth in claim 12 wherein said controller is configured to assign a locked state to each of the open switches in response to receiving the door lock signal from any of said lock switches.

16. A vehicle as set forth in claim 12 wherein said open switches are mechanically isolated from said electric door latch mechanisms.

17. A vehicle as set forth in claim 12 wherein said lock switches are mechanically isolated from said electric door latch mechanisms.
